(19) United States
(12) Patent Application Publication
(10) Pub. No.: US 2013/0054928 A1
(43) Pub. Date: Feb. 28, 2013

(54) META DATA GROUP CONFIGURATION METHOD HAVING IMPROVED RANDOM WRITE PERFORMANCE AND SEMICONDUCTOR STORAGE DEVICE USING THE METHOD

(71) Applicant: Jung Been Im, Anyang-si (KR)

(72) Inventor: Jung Been Im, Anyang-si (KR)

(21) Appl. No.: 13/494,372

(22) Filed: Jun. 12, 2012

(30) Foreign Application Priority Data
Aug. 30, 2011 (KR) 10-2011-0087122

(51) Int. Cl. G06F 12/02; G06F 12/00

(52) U.S. Cl. 711/170; 711/202; 711/E12.002

(57) ABSTRACT

A semiconductor storage device having an improved write performance is disclosed. The semiconductor storage device includes a plurality of memory devices, with each memory device associated with a logical address space comprising contiguous logical addresses. A controller of the semiconductor storage device is configured to allocate a plurality of meta data groups for each memory device, with each meta data group assigned a set of logical addresses of the logical address space. The controller may also configured to assign a first logical address of a logical address space to a first meta data group and a second logical address of the logical address space, contiguous to the first logical address, to a second meta data group, where the second meta data group is different than the first meta data group.

### CROSS-REFERENCE TO RELATED APPLICATIONS

This U.S. non-provisional patent application claims priority under 35 U.S.C. §119 of Korean Patent Application No. 10-2011-0087122, filed on Aug. 30, 2011, the entire contents of which are hereby incorporated by reference.

### BACKGROUND

Embodiments of the present disclosure relate to semiconductor storage devices, and more particularly, to a meta data group configuration method in a semiconductor storage device including a plurality of memory devices and a storage device using the configuration method.

### SUMMARY

Embodiments of the present disclosure provide a method of constituting a meta data group defining a relation between a logical space and a physical space in a semiconductor storage device.

In one embodiment, a method of creating a plurality of meta data groups for a storage including a plurality of memory devices comprises: associating a logical address space including a plurality of contiguous sequential logical addresses with the storage, assigning a first logical address of the logical address space to a logical space of a first meta data group, and assigning a second logical address immediately sequential to the first logical address to a logical space of a second meta data group, where the second meta data group is different than the first meta data group.

In one embodiment, a method of associating adjacent sequential logical addresses of a logical address space of a semiconductor storage device to a plurality of meta data groups for that device comprises associating a plurality of sets of logical addresses of the logical address space to a respective plurality of meta data groups, each set of logical addresses comprising an equal amount of logical addresses, wherein none of the logical addresses in a set of logical addresses are immediately sequential to each other in the logical address space.

In one embodiment, a semiconductor storage device comprises a plurality of semiconductor memory chips, each chip associated with a respective logical address space comprising contiguous logical addresses, and a controller configured to allocate a plurality of meta data groups for each chip, each meta data group being assigned a set of logical addresses of the logical address space, wherein the controller is configured to assign a first logical address of a first logical address space to a first meta data group and a second logical address of the first logical address space, contiguous to the first logical address, to a second meta data group, where the second meta data group is different than the first meta data group.

### BRIEF DESCRIPTION OF THE FIGURES

The above and other aspects and features of the disclosure will become apparent by describing in detail exemplary embodiments thereof with reference to the attached drawings, in which:

FIG. 1 is a block diagram of semiconductor storage device in accordance with some embodiments.

FIG. 2 is a block diagram illustrating an example of the controller illustrated in FIG. 1.

FIG. 3 is a block diagram illustrating an example of the memory device illustrated in FIG. 1.

FIG. 4 is a drawing illustrating a general arrangement example of meta data groups with respect to a logical address space.

FIG. 5 is a drawing illustrating an example of creating a plurality of meta data groups in a same chip according to FIG. 4.

FIG. 6 is a drawing illustrating an example of over provision in a meta data group in accordance with FIG. 5.

FIG. 7 is a drawing illustrating a method of creating meta data groups in accordance with some embodiments.

FIG. 8 is a detailed drawing of an embodiment of FIG. 7.

FIG. 9 is a drawing illustrating an example of improving random write performance according to FIG. 8.

FIG. 10 is a control flow chart of creating meta data groups in accordance with some embodiments.

FIG. 11 is a table referencing exemplary numbers that are assigned when meta data groups in accordance with FIG. 10 are grouped.

FIG. 12 is a block diagram of an exemplary data processing device applying the meta data grouping in accordance with some embodiments.

FIG. 13 is a block diagram of another example of a fusion memory system applying the meta data grouping in according with some embodiments.

FIG. 14 is a block diagram of another example of a computing system applying the meta data grouping in accordance with some embodiments.

### DETAILED DESCRIPTION OF THE EMBODIMENTS

Various example embodiments will now be described more fully hereinafter with reference to the accompanying drawings, in which exemplary embodiments are shown. The present invention may, however, be embodied in many different forms and should not be construed as limited to the example embodiments set forth herein. That is, these example embodiments are just that—examples—and many implementations and variations are possible that do not require the various details herein. It should also be emphasized that the disclosure provides details of alternative examples, but such listing of alternatives is not exhaustive. Furthermore, any consistency of detail between various examples should not be interpreted as requiring such detail—it is impracticable to list every possible variation for every feature described herein. The language of the claims should be referenced in determining the requirements of the invention. In the drawings, the sizes and relative size of layers and regions may be exaggerated for clarity. Like numerals refer to like elements throughout.

The terminology used herein is for the purpose of describing particular embodiments only and is not intended to limit the invention. As used herein, the singular terms “a,” “an” and “the” should not exclude the plural forms as well, unless the context clearly indicates otherwise. As used herein, the term “and/or” includes any and all combinations of one or more of the associated listed items. It will be understood that when an element or a layer is referred to as being “on,” “connected to” or “coupled to” another element or layer, it may be directly on, connected to, or coupled to the other element or layer or intervening elements or layers may be present. In contrast, when an element is referred to as being “directly on,” “directly connected to” or “directly coupled to” another element or layer, there are no intervening elements or layers present. Other words used to describe the relationship between elements or layers should be interpreted in a like fashion (e.g., “between” versus “directly between;” “adjacent” versus “directly adjacent,” etc.).

It will be further understood that the terms “comprises”, “comprising,” “includes” and/or “including”, when used herein, specify the presence of stated features, integers, steps, operations, elements, and/or components, but do not preclude the presence or addition of one or more other features, integers, steps, operations, elements, components, and/or groups thereof.

It will be also understood that although the terms first, second, third etc. may be used herein to describe various elements, components, regions, layers and/or sections, these elements, components, regions, layers, and/or sections should not be limited by these terms. Unless otherwise indicated, these terms are only used to distinguish one element, component, region, layer, or section from another element, components, region, layer, or section. Thus, a first element, components, region, layer, or section in some embodiments could be termed a second element, components, region, layer, or section in other embodiments, and, similarly, a second element, components, region, layer, or section could be termed a first element, components, region, layer, or section without departing from the teachings of the disclosure. Exemplary embodiments explained and illustrated herein may include their complementary counterparts.

Locational terms, such as “beneath,” “below,” “lower,” “above,” “upper” and the like, may be used herein for ease of description to describe one element or feature's relationship to another element(s) or feature(s) as illustrated in the figures. It will be understood that the locational terms may be relative to a device and are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the locational descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and/or the present application and will not be interpreted in an idealized or overly formal sense unless expressly so defined herein.

It should also be noted that in some alternative implementations, the functions/acts described may occur out of the order noted in the figures or the specification unless expressly stated otherwise. For example, two figures shown in succession may in fact be executed substantially concurrently or may sometimes be executed in the reverse order, depending upon the steps, functionality, or acts involved.

Hereinafter, example embodiments will be explained in detail with reference to the accompanying drawings.

Flash memories are increasingly being used as a memory of a computer, a solid state drive/disk and a memory card. As the use of portable information equipment, such as a cell phone, a PDA, a digital camera or the like, rapidly increases, flash memory is being adopted in a semiconductor storage device and is being widely used.

In some semiconductor storage devices, the amount of memory (meta memory) set aside to store meta data of the storage device is limited. Meta data may include the information needed to manage the storage device. There may be a predefined and/or fixed area of physical memory set aside for storing meta data. For example, there may be a contiguous set of physical memory set aside for storing meta data. For the flash memory, the flash meta data may include the information needed to manage the flash memory. Because of the potential limited capacity of a storage device (e.g. a RAM) storing a meta memory, all the meta data stored in a flash memory of the storage device may not be loaded into a meta memory of the storage device. In some embodiments, the meta memory (e.g. a meta memory stored in the RAM) may store information regarding the flash memory as a whole, while the flash memory may maintain meta data regarding the data or memory in the flash memory. In some embodiments, the flash memory may have a plurality of contiguous physical addresses (comprising several physical blocks) and/or a plurality of physical blocks set aside to store the meta data. In some embodiments, a block of flash memory that stores meta data may not store any other type of data (e.g. user data). In other embodiments, a block of flash memory that stores meta data may also store other types of user data.

There may be different groups of meta data related to the flash memory, where each group may be related to one or more of a layer of memory in the flash memory, and/or a portion of the flash memory (i.e. a grouping of adjacent blocks in flash memory, a grouping of a specific number of blocks in flash memory, etc.). Some meta groups may be stored in the RAM. Other meta groups, e.g. those relating to the usage of actual blocks in flash memory, may be stored in the flash memory itself.

Write amplification may occur in flash memory devices because flash memory is often required to be erased before it is re-written. With the garbage collection and wear leveling procedures that occur in flash memory management, data existing in the flash memory is re-written in the flash memory, which may requiring the additional re-writing also of user data and metadata.

In a flash memory, it may be useful to associate a logical data space with a physical data space larger than the logical data space, often referred to as over-provisioning. For example, when data is re-written in a block of flash memory with a high over provision ratio, new logical addresses may not need to be used as often in association with new physical addresses of that data if the physical address space associated with that block is larger than the logical address space.

When configuring a meta data group that stores data to manage a semiconductor storage device, performance of the semiconductor storage device may be better if the meta group is configured with a high over provision ratio. Over provisioning is one method by which to alleviate write amplification. A flash memory with a high over-provisioning ratio may need a larger meta data space in the flash memory and may incur additional overhead when returning a user block after its use (i.e. deleting the contents and re-configuring a data block into a reserved block), but an associated increase in efficiency during write performance may alleviate overheard concerns.

An over provision ratio may be calculated by subtracting the user capacity (i.e. the logical data space) from the physical capacity of a storage device, and then dividing that subtracted amount by the user capacity. For example, an over provision ratio may be expressed as a percentage (e.g. over provision ratio=100%*(physical data space−logical data space)/(logical data space). The over provision ratio may be used to describe, for example, a ratio of physical space to a logical space in a meta data group. An over-provisioning ratio greater than 150% may be high. In some embodiments, an overprovisioning ratio greater than 200% may be a high ratio.

In a semiconductor storage device having one or more memories, for example, one or more flash memories, if an over provision ratio is low, performance of random write may be deteriorated. Conversely, if an over provision ratio is high, the device may have reduced write amplification, as well as increased endurance and performance.

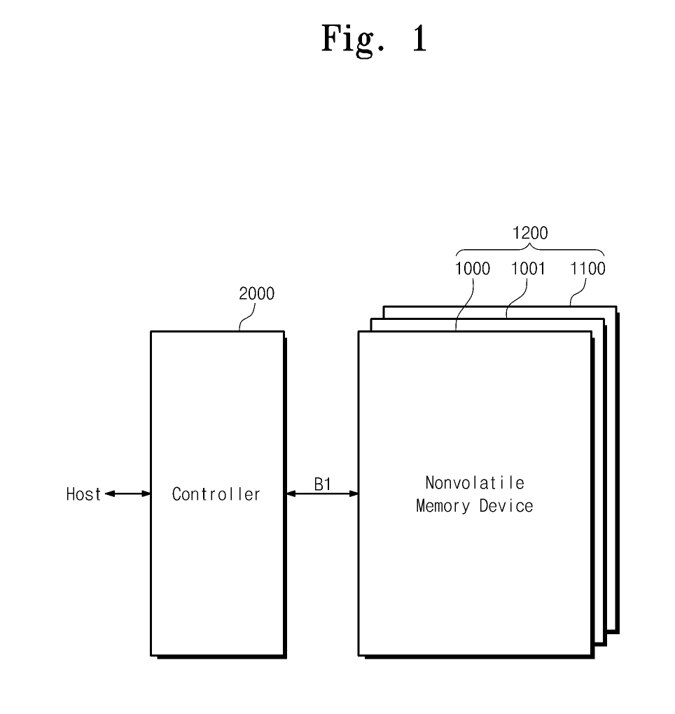

FIG. 1 is a block diagram of semiconductor storage device in accordance with some embodiments.

Referring to FIG. 1, an exemplary semiconductor storage device includes a storage 1200 and a controller 2000. The storage 1200 may be used to store data information having various data types such as a text, a graphic, a software core, or the like. The storage 1200 may be embodied by various nonvolatile memories such as a NAND flash memory, a NOR flash memory, a phase change memory device (PRAM), a ferroelectric memory device (FeRAM), a magnetic RAM (MRAM), or the like. Each memory may be implemented, for example, on a semiconductor chip.

The storage 1200 may include a plurality of memory devices, such as those illustrated in FIG. 1 (e.g. memory devices 1000, 1001, and 1002). The controller 2000 may group logical addresses for the data spaces of the plurality of memory devices in such a way that the logical addresses for the storage 1200 are arranged to be dispersed by a fixed amount or ratio among the memory devices. For example, if there are 100 logical addresses to be grouped for 10 data spaces of the plurality of memory devices, each data space/memory device may be allocated 10 logical addresses. Each of the meta data groups that store the data used to manage the storage 1200 may comprise a set of physical addresses of the storage 1200 and may be assigned a respective set of logical addresses.

The controller 2000 may group logical addresses associated with a single memory device, where the logical addresses are not contiguous or immediately sequential logical addresses, into a single meta data group, where the meta data group may include data for managing the single memory device.

The controller 2000 may control the storage 1200 in response to an external request provided from a host. The controller 2000 may compress data provided from the outside and may store the compressed data in the storage 1200. Compressing data may effectively use the storage 1200 (e.g., to store large amounts of data at a low cost). Also, compressing data may reduce the amount of traffic of bus B1 connected between the storage 1200 and the controller 2000.

In an embodiment with a semiconductor storage device including a small capacity meta memory, only meta data associated with data that has been recently requested from or stored in the memory devices may be loaded into a meta memory RAM of the controller 2000. For example, because of capacity limitations of the meta memory, meta data that was stored in the meta memory corresponding to previously requested write data may be unloaded and meta data corresponding to currently or recently requested write data may be loaded. In some embodiments, the meta data in the meta memory may be loaded and unloaded via a FIFO method, via a FILO method, or via other methods known in the art.

In one embodiment, the meta data comprises data used to manage the storage 1200 such as a flash memory and may include at least one of a name of file data, a directory name related to file data, an access authority to file data, and visual information generated by file data. The meta data may also include state information about a block area and a page area that is available in the storage 1200. The meta data may also include any other information needed to manage the storage 1200.

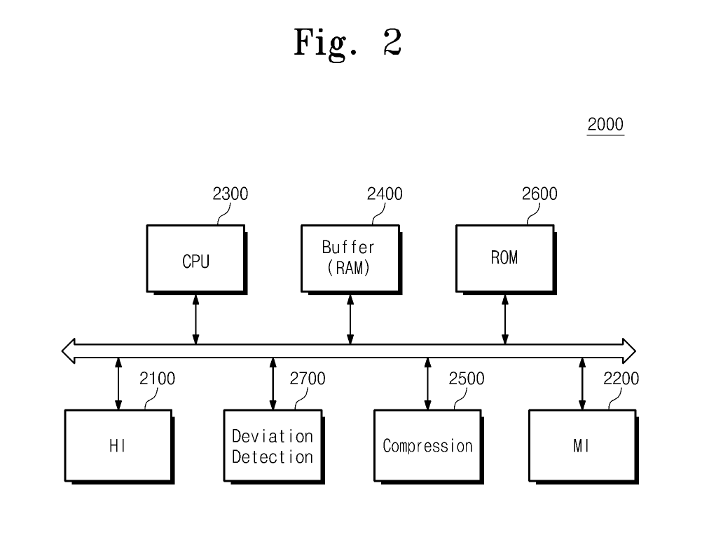

FIG. 2 is a block diagram illustrating an example of the controller illustrated in FIG. 1.

Referring to FIG. 2, the controller 2000 may include a first interface (e.g., a host interface HI) 2100, a second interface (e.g., a memory interface MI) 2200, a central processing unit (CPU) 2300, a buffer (RAM) 2400, a compression block 2500, a deviation detection portion 2700 (for example, an error correction portion) and a ROM 2600. The controller 2000 of FIG. 2 may enable a high over provision ratio.

The first interface (HI) 2100 may be configured to interface with the outside of the controller (or a host) and the second interface (MI) 2200 may be configured to interface with the storage 1200 of FIG. 1. The central processing unit (CPU) 2300 may be configured to control the operation of the controller 2000. For example, the CPU 2300 may be configured to manage, among other things, a firmware like a flash translation layer (FTL) stored in the ROM 2600. The flash translation layer (FTL) may be used to manage mapping information for a flash memory. The FTL may also be used to manage wear-leveling of the storage 1200, bad block management and data conservation in the case of, for example, an unexpected power cut-off.

The buffer 2400 may be used to temporarily store data transferred from the outside through the first interface (HI) 2100. The buffer 2400 may be used to temporarily store data transferred from the storage 1200 through the second interface (MI) 2200.

The compression block 2500 may be configured to compress data of the buffer 2400 in response to a control or command of the CPU 2300 (or a control or command of the FTL managed by the CPU 2300). The compressed data may be stored in the storage 1200 through the second interface (MI) 2200. In some embodiments, the compression block 2500 may be configured to decompress data read from the storage 1200 in response to a control or command of the CPU 2300 (or a control or command of the FTL managed by the CPU 2300).

A compression function of the compression block 2500 may be selectively performed. In some embodiments, input data may be stored in the storage 1200 through the buffer 2400 without data compression. For example, an on/off switch or function of the compression block 2500 may be set or performed depending on data being input. In some embodiments, if very large amounts of data are provided to the semiconductor storage device or the energy that would be consumed to compress the provided data is relatively high because the data size is very small, an operation of the compression block 2500 may be set to off. For example, if the provided data is multimedia data or a very small amount of data, an operation of the compression block 2500 may be set to off. An on/off of the compression block 2500 may be performed or set by a hardware (e.g., register) or via software. In some embodiments, data provided from the outside may be directly stored in the storage 1200 through the first and second interfaces (HI and MI) 2100 and 2200 without going through the buffer 2400.

In some embodiments, a meta data group, comprising a set of physical addresses, and which may comprise a set of contiguous or immediately sequential physical addresses, is assigned a set of logical addresses which may not be adjacent to each other. In some embodiments, the controller 2000 assigns a first logical address to a logical space of a first meta data group. A second logical address adjacent to the first logical address is assigned to a second meta data group different from the first meta data group. For example, the second logical address is immediately sequential to the first logical address. In some examples, the first logical address and second logical address are contiguous logical addresses. As explained further below, in these embodiments, a ratio of over provision of physical space to logical space becomes high and thereby random write performance may be improved.

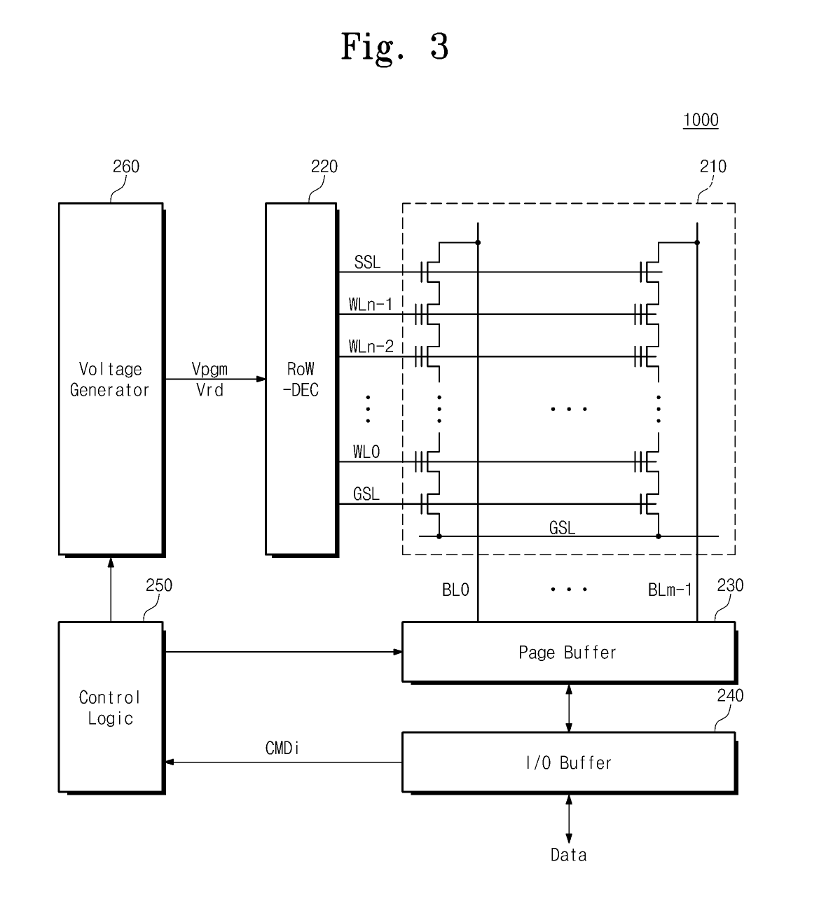

FIG. 3 is a block diagram illustrating an example of the storage illustrated in FIG. 1.

Referring to FIG. 3, the storage 1200 is embodied by a memory device 1000, such as a flash memory, among various nonvolatile memory devices NVM.

The flash memory 1000 includes a memory cell array 210, a row decoder 220, a page buffer 230, an input/output (I/O) buffer 240, control logic 250, and a voltage generator 260.

The memory cell array 210 includes a plurality of memory cells connected to a bit line and a word line. The memory cell array 210 may include a main area in which a message field of write (i.e. program or user) data is stored and a spare area in which control information (e.g. meta data) related to the message field is stored. Write data may be stored at plural pages in memory cells connected to one word line. In a memory device including multi level cells, write data may be stored at plural pages in memory cells connected to one word line.

The row decoder 220 selects a word line in response to a row address. The row decoder 220 may transfer word line voltages (e.g., Vpgm, Vrd, etc.) provided from the voltage generator 260 to word lines. When a program operation is performed, the row decoder 220 may apply a program voltage Vpgm of about 15V-20V and a verification voltage Vfy to a selected word line and may apply a pass voltage Vpass to one or more unselected word lines. When a read operation is performed, the row decoder 220 may apply a read voltage Vrd provided from the voltage generator 260 to a selected word line and may apply a read voltage Vread of about 5V to one or more unselected word lines provided from the voltage generator 260.

The page buffer 230 may operate as a write driver or as a sense amplifier according to an operation mode. For example, the page buffer 230 may operate as a sense amplifier in a read operation mode and may operate as a write driver in a program operation mode. When a program operation is performed, the page buffer 230 may load data of one page unit. For example, the page buffer 230 may receive data to be programmed through the input/output (I/O) buffer 240 and may store the data in an internal latch. When writing (programming) the loaded data, the page buffer 230 may provide a ground voltage (e.g., 0V) to a bit line of memory cells to be programmed. The page buffer 230 may also provide a precharge voltage (e.g., Vcc) to a bit line of program inhibit memory cells.

The input/output (I/O) buffer 240 may temporarily store an address or write data received through an input/output (I/O) pin. The input/output (I/O) buffer 240 may transfer a stored address to an address buffer (not shown), program data to the page buffer 230 and a command to a command register (not shown). When a read operation is performed, read data provided from the page buffer 230 may be output to the outside through the input/output buffer 240.

In some embodiments, when a program operation is performed, the control logic 250 receives a command CMDi provided from the controller 2000 and controls the page buffer 230 and the voltage generator 260 so that program data is written in a selected memory cell. In some embodiments, the control logic 250 controls the page buffer 230 and the voltage generator 260 in response to a command of the controller 2000 so that data in a selected area is read.

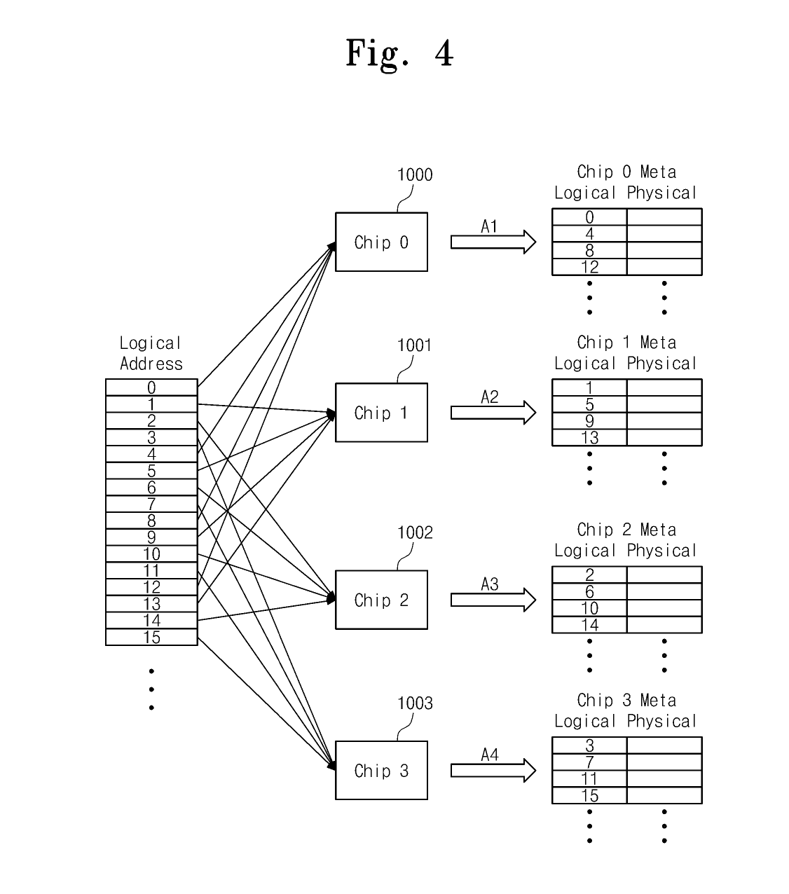

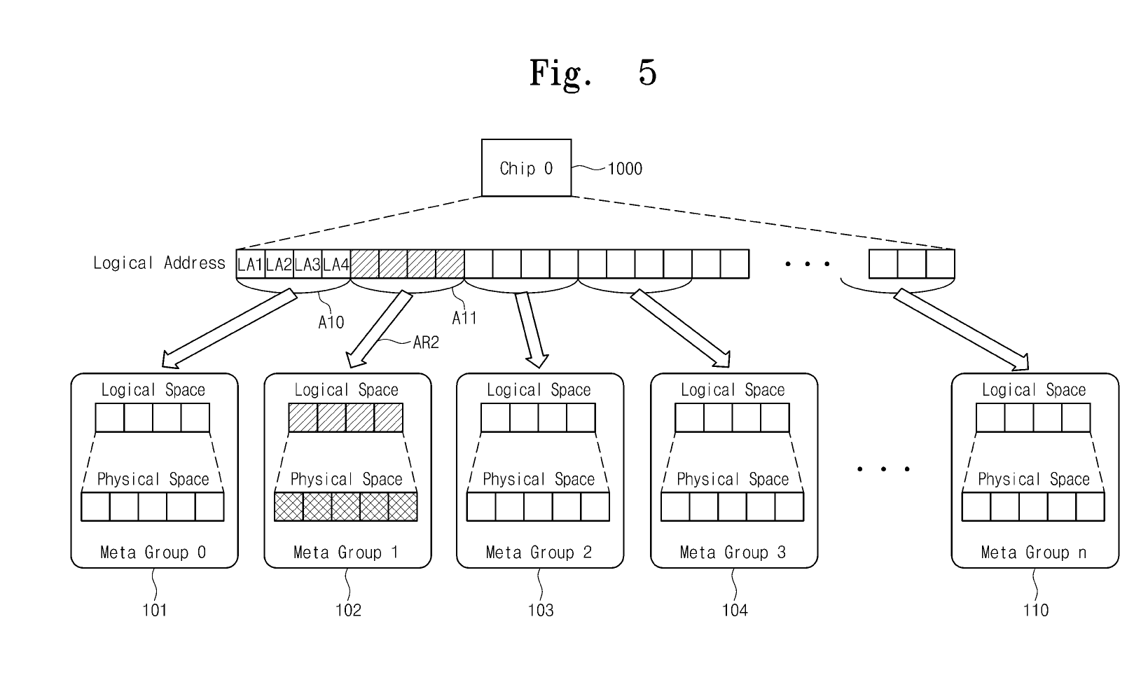

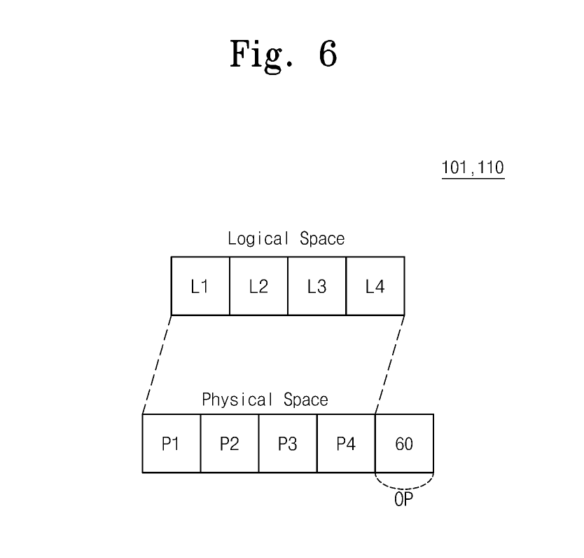

FIG. 4 is a drawing illustrating a general arrangement example of meta data groups with respect to a set of logical addresses. FIG. 5 is a drawing illustrating an example of meta data groups associated with a same chip according to FIG. 4. FIG. 6 is a drawing to describe an exemplary over provision in a meta data group in accordance with FIG. 5.

Referring to FIG. 4, in the case that a semiconductor storage device includes a plurality of memory devices 1000, 1001, 1002 and 1003, with each memory device maintained in one or more semiconductor chips, to maximize an access parallelism, logical addresses are assigned to be evenly dispersed to each memory device, such that each memory device is allocated a fixed and/or equal amount of logical addresses. For example, to evenly disperse an access to the plurality of storage devices, a logical address 0 is assigned to a first storage device 1000, a logical address 1 is assigned to a second storage device 1001, a logical address 2 is assigned to a third storage device 1002, and so forth.

In some embodiments, each memory device may operate in parallel. In these embodiments, access operations (such as reading and writing of data of the chip) may be performed in parallel or during the same time period. For example, in some embodiments, each memory device may be maintained on respective single semiconductor chips, and each chip may operate in parallel. In some embodiments, one or more of the memory devices may be maintained on respective memory banks of a same chip. In these embodiments, the respective memory banks on a same chip may operate in parallel. In some embodiments, each memory device may be maintained on a semiconductor package (e.g. on the same or different memory modules). In these embodiments, the respective packages may operate in parallel. The size and structure of the memory device is not limited to the examples described herein.

In FIG. 4, as arrows A1, A2, A3 and A4 indicate, logical addresses are sequentially assigned to the memory devices 1000, 1001, 1002 and 1003 respectively. Meta data related to a corresponding memory device is managed and stored based on the sequentially arranged logical addresses.

For each meta data group related to a single memory device, a physical address space comprising a plurality of physical addresses corresponding to a logical address space (comprising logical addresses) is assigned. When assigning a space of physical addresses for each meta data group, more physical address space (i.e. more physical addresses) is assigned for a meta data group than logical address space (i.e. the number of logical addresses) assigned to the meta data group. This may help to alleviate write amplification issues and increase an over provision ratio for the meta data groups of the memory devices and for the semiconductor storage device as a whole. The physical address space may comprise contiguous physical addresses, such that the physical address space associated with each meta data group comprises a set of immediately sequential physical addresses.

For example, if data associated with a logical address assigned to a meta data group (and stored at a first physical address of the meta data group) needs to be updated, the new data associated with the logical address may be stored at a second physical address of the meta data group and a mapping table of the meta data group (e.g. a table that keeps track of the associations between the physical addresses of the meta data group and the logical addresses corresponding to those physical addresses) may be updated. In this example, a new association would not need to be created, as extra physical space (physical addresses that have not yet been used) is available for the meta data group. In this example, the same logical address may be updated to correspond to the second physical address. When using the meta data group as described above, with a larger number of physical addresses than logical addresses assigned to or associated with the meta data group, a write operation may be more easily performed. In these examples described above, an over provision ratio of the meta data group (and thus the memory device) may be high, and random write performance of semiconductor storage device may be improved.

Due to, for example, an issue with a mapping algorithm characteristic or a hardware resource (e.g., meta RAM capacity) in the semiconductor storage device, the logical addresses assigned to a single memory device may be divided by a fixed size into sets of logical addresses that are assigned to meta data groups of a single memory device. This method may be used instead of having one large meta data group that manages the memory of the whole semiconductor storage device. For example, the entire logical data space allocated to a specific storage device may be divided by a fixed size into sets of logical addresses for each memory device, with respective sets to be assigned to the plurality of meta data groups associated with respective memory devices, like those shown in FIG. 5.

Referring to FIG. 5, logical addresses of the first memory device 1000 are assigned to meta data groups 101, 102, 103, 104, . . . , 110. Referring to any one meta data group (e.g. meta data group 101), the size of the physical address space (i.e. the number of physical addresses) in the meta data group 101 is greater than the size of the logical address space (i.e. the number of logical addresses) assigned to the meta data group, as illustrated in FIG. 6. For example, a space 60 of FIG. 6 is a physical address space that is an over provision space OP that is additionally assigned to the meta data group. In FIG. 6, a space P1, a physical address space in the physical space, is assigned to correspond to a space L1 in the logical address space, P2 in the physical space is assigned to correspond to a space L2 in the logical address space, and so forth. In some embodiments, an over provision space OP may be used if data at another physical space (e.g., space P1) becomes invalid, and the space L1 associated with the other physical address space can be associated instead with the over provision space OP. As mentioned above, this may also help to alleviate write distribution issues.

In the embodiment depicted in FIG. 6, an over provision ratio in one meta data group is 125% (i.e., (5−4)/4=125%).

In the semiconductor storage device, given the distribution of logical addresses, a random write may be performed on a small range of logical addresses. The performance of the semiconductor storage device may be improved by improving a performance of the random write.

Referring back to FIG. 5, only a part of meta data group among the whole meta data group in a single memory device may be accessed for a random write access to a single memory device among the entire random write access operation of a host. For example, in the case that a random write occurs with respect to logical address set A11, only meta data group 102 is accessed as shown through an arrow AR2. If a random write occurs with respect to logical address set A10, which include a plurality of logical addresses LA1, LA2, LA3 and LA4, only meta data group 101 is accessed. In this embodiment, logical addresses adjacent to each other are grouped into a same meta data group.

If a ratio of over provision in one meta data group is 125%, a random write is performed using only an over provision ratio of 125%. Performance of random write in this embodiment may be limited due to a comparatively low over provision ratio.

As described above with respect to FIGS. 4 to 6, if an over provision ratio in a meta data group is increased, the performance of random write is improved and the performance of semiconductor storage device may be improved.

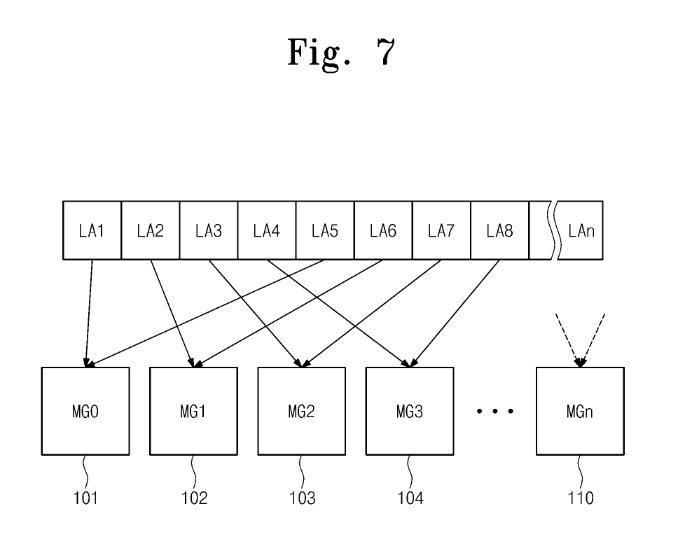

FIG. 7 is a drawing illustrating a method of creating meta data groups in accordance with some embodiments.

The plurality of logical addresses assigned to a memory device may be sequentially arranged. In some embodiments, the plurality of logical addresses and the plurality of associated physical addresses may be assigned to meta data groups of the memory device. Each meta data group may have an equivalent sized logical address space (i.e. the same number of logical addresses associated with each meta data group). The physical address space associated with a meta data group may be larger than the logical address space associated with the meta data group. The physical address space associated with a meta data group may include one or more blocks and may include a set of immediately sequential or contiguous physical addresses. In some embodiments, the number of blocks in a memory device may be dispersed in equal amounts, such that each meta data group is assigned a same number of blocks in which to store data. In some embodiments, adjacent logical addresses are not assigned to the same meta data group. For example, a first logical address LA1 may be assigned to a logical address space of a first meta group 101 and a second logical address LA2 adjacent to the first logical address LA1 may be assigned to a logical address space of a second meta data group 102, which is different from the first meta data group 101.

In the embodiments depicted in FIG. 7, for example, logical addresses LA1 and LA5, which are not sequential logical addresses and which are not spaced next to each other in the logical address space of the storage device, are assigned to the same meta data group 101. In these embodiments, logical addresses LA3 and LA4 that are immediately sequential and that are spaced next to each other in the logical address space of the storage device are assigned to two different meta data groups 103 and 104 respectively.

In a semiconductor storage device including a plurality of memory devices, where each device may be associated with a subset of the logical addresses of the semiconductor storage device based on, for example, a number of memory devices of the semiconductor storage device, meta data grouping similar to that described in relation to the embodiment depicted in FIG. 7 may be applied.

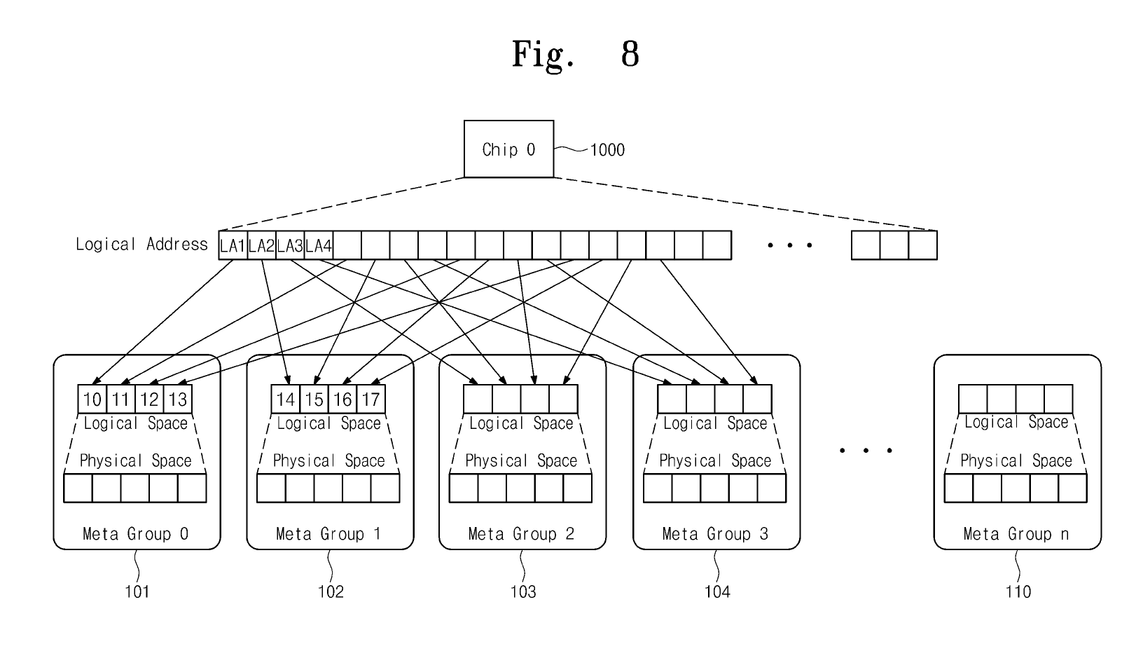

FIG. 8 is a detailed depiction of the embodiments shown in FIG. 7.

Referring to FIG. 8, logical addresses LA1 and LA2 are adjacent, sequential addresses in the logical address space of the semiconductor storage device (and possibly of the single memory device). Similarly, logical addresses LA2 and LA3 are adjacent, sequential addresses in the logical address space of the semiconductor storage device (and possibly of the single memory device).

When the logical address LA1 is assigned to a logical space 10 of a first meta data group (e.g., the first meta data group 101), the logical address LA2 adjacent to the logical address LA1 is assigned to a logical space 14 of another meta data group (e.g., the second meta data group 102). In these embodiments, the controller 2000 is connected to a plurality of memory devices, with each memory device associated with a subset of the logical addresses of the semiconductor storage device. The size of the subset (e.g., the number of address in the subset) of logical addresses associated memory device may be the same or similar. In these embodiments, meta data groups are created that include a logical address space and a physical address space associated with a single memory device. The meta data groups associated with each memory device include logical addresses that are not sequential or adjacent in the logical address space dispersed to the respective memory device.

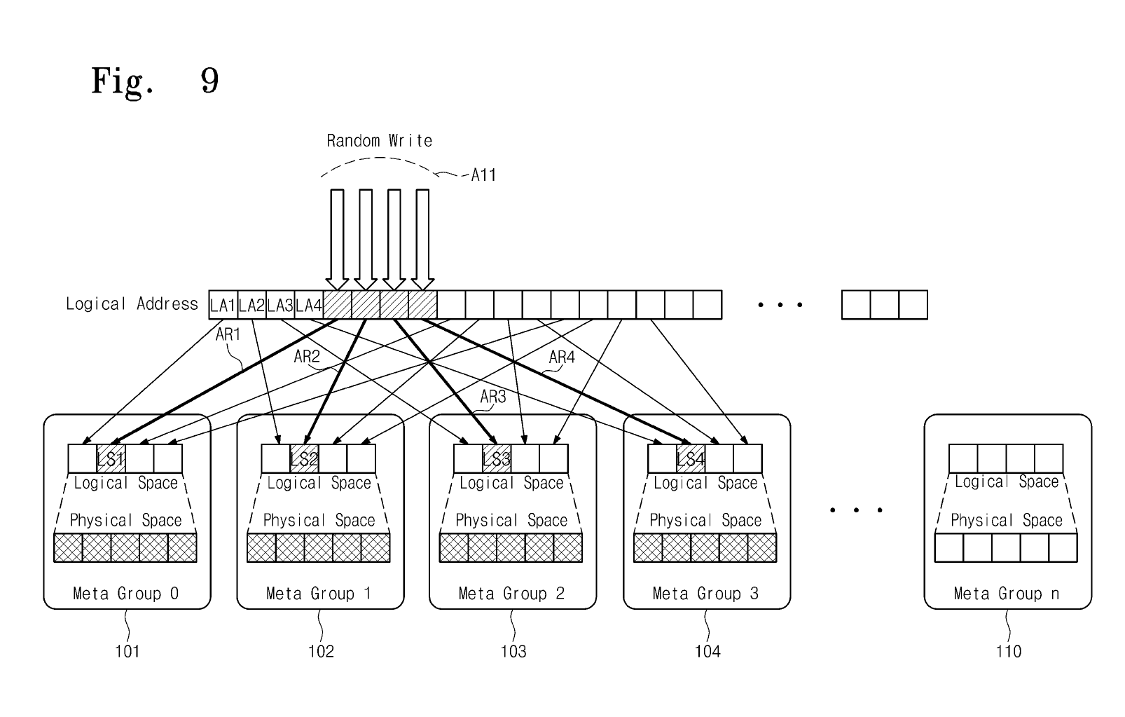

FIG. 9 is a drawing illustrating an example of improving random write performance according to FIG. 8.

In some embodiments, when a random write occurs with respect to a set of logical addresses (e.g. set A11 of FIG. 9), a random write operation is dispersed with respect to meta data groups 101, 102, 103 and 104. In this embodiment, in a single meta data group, an over provision ratio is increased by four times compared with a meta data group arrangement like that described with respect to FIG. 5. As mentioned above, an over provision ratio is calculated as (physical space−logical space)/(logical space). In the example described above, there are 20 physical spaces potentially available for the four logical addresses associated with the data to be written. The over provision ratio for the exemplary memory device of FIG. 9 is (20−4)/4, which is 400%. In an embodiment in which a random write operation is performed with an over provision ratio of 400%, performance of random write of semiconductor storage device is improved.

Logical addresses of a memory device may be assigned to meta data groups using a function that includes the logical address as a parameter. For example, the logical address may be assigned to meta data group n based on the formula: meta data group n=function (logical address).

In some embodiments, the function may use a remainder operation value of logical address. For example, a modulo function may be used. In other embodiments, a bit operation with respect to logical address may be used. Known caching functions may also be used to assign logical addresses to meta data groups.

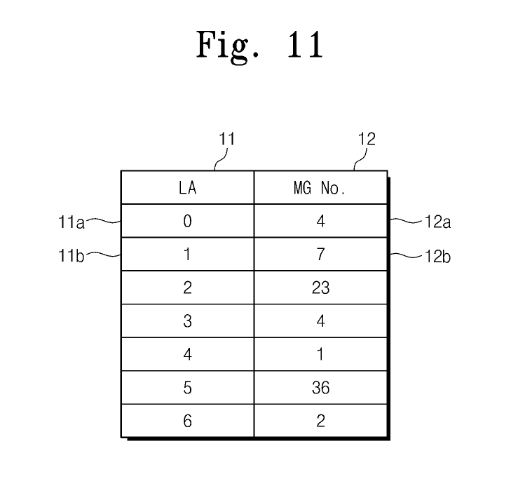

In an embodiment in which it may be difficult to set a specific function between a logical address space and the meta data groups, a meta data group allocation table representing the relationship between the logical address space and the meta data groups, like that depicted in FIG. 11, may be created, and a method using the table may be used.

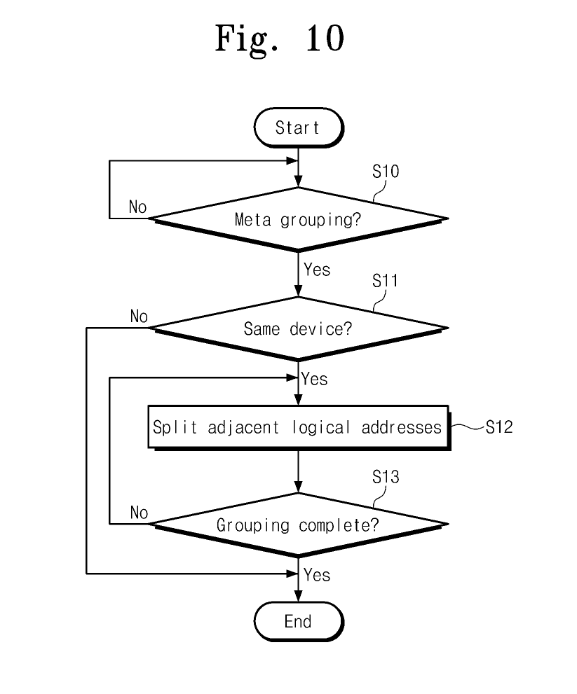

FIG. 11 is an example of a meta data group allocation table. In the example depicted in FIG. 11, the assignation of logical addresses to meta data groups may occur in accordance with the method set forth in FIG. 10. For example, field 11 represents a logical address LA and field 12 represents a meta data group number corresponding to the logical address. For example, a logical address 0 illustrated in a lower area 11a of the area 11 corresponds to meta data group 4 as illustrated in a lower area 12a of the area 12.

The meta data allocation table and/or the function for assigning the logical addresses to meta data groups may be performed in a device initialization step. For example, it may be performed by predicting an access pattern of the memory device. In other examples, it may be performed by an adaptive method through a real time analysis of logical addresses that are written or accessed in a memory device.

FIG. 10 is a control flow chart depicting the creation of meta data groups in accordance with some embodiments. The control flow of FIG. 10 may be performed, for example, by the controller 2000 of FIG. 2. In some embodiments, it may also be performed by a host. The meta data groups may be assigned before the first use of the storage 1200, or may be created as each memory device is first used. The allocation or assignation of logical address and physical address space to the meta data groups is not limited to the time frames discussed herein, but may be accomplished when most suitable for the host, for the storage 1200, and/or for each individual memory device.

The first step in creating the meta data groups is to determine if the meta data groups for the storage 1200 should be created or updated (S10). If they should not be created or updated, the method returns to a waiting position. If they should be created or updated, then the method may determine if the meta data groups are assigned a logical and physical address space from the same memory device. (S11). In some embodiments, before determining if the meta data groups are assigned a logical address space and physical address space from the same memory device, the entire logical address space of the storage 1200 may be split up into fixed portions of equal size, such that each memory device in the storage 1200 is allocated a respective portion or subset of the logical address space. If, in step S11, the meta data groups are to be created for a logical and/or physical address space spanning more than one device, the method may end. In other embodiments, the method described in the embodiments set forth, for example, in FIG. 7 may be used to assign or allocate meta data groups across a storage 1200. If, in step S11, the meta data groups are to be allocated logical and physical space associated with a single memory device, meta data groups are created or constituted as described, for example, in FIG. 7, with adjacent logical addresses dispersed into different meta data groups. (S12). If the logical address space of the single memory device is completely allocated into different meta data groups (S13), the meta data groups are considered created and the method of creating meta data groups is fully completed. Using the method described above, an over provision ratio of each of the meta data groups becomes high and performance of random write is improved.

Using the control flow of FIG. 10, as described in FIG. 9, if the creation of meta data groups is performed by assigning a larger physical address space than a logical address space to each respective meta data group, an over provision ratio may be high and the performance of random write is improved.

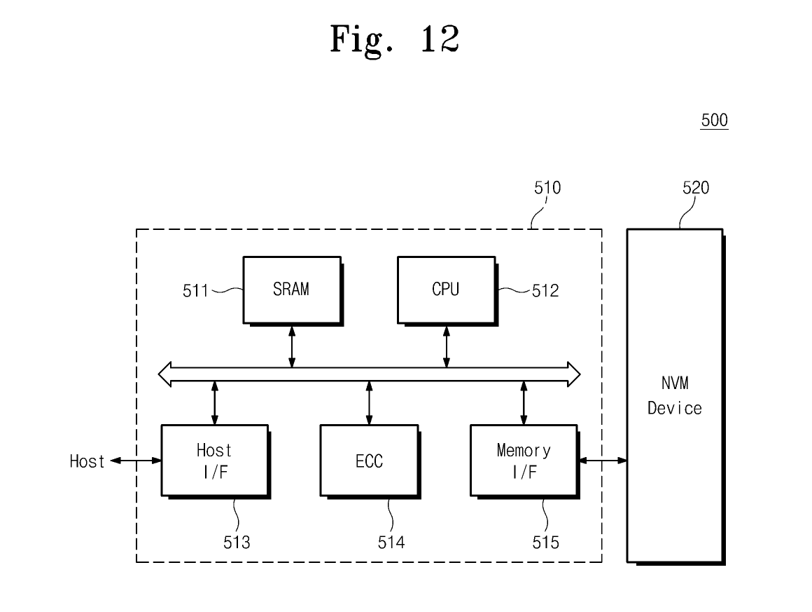

FIG. 12 is a block diagram of an application example as applied to a data processing device. Referring to FIG. 12, the data processing device 500 includes a nonvolatile memory device 520 and a memory controller 510.

The nonvolatile memory device 520 may be embodied by the flash memory described in FIG. 3. The memory controller 510 controls the nonvolatile memory device 520 through a memory interface 515. A memory card or a solid state disk (SSD) may be provided by combining the nonvolatile memory device 520 with the memory controller 510.

A SRAM 511 in the memory controller 510 may be used as an operation memory of a central processing unit 512. A host interface 513 is in charge of an interface between the data processing device 500 and a host and may include a data exchange protocol.

An error correction code (ECC) block 514 detects and corrects an error that may be included in data read from the nonvolatile memory device 520.

The memory interface 515 is in charge of an interface between the memory controller 510 and the nonvolatile memory device 520.

The central processing unit 512 performs all the control operations for a data exchange of the memory controller 510. Although not illustrated in the drawing, the data processing device 500 may further include a ROM (not shown) storing code data for an interface with a host and/or a nonvolatile RAM (not shown).

The nonvolatile memory device 520 may be embodied by a multi-chip package including a plurality of flash memory chips.

In the case that the nonvolatile memory device 520 includes a plurality of flash memory chips, the memory controller 510 assigns logical addresses to each chip by a fixed size. When creating meta data groups, as described above, for example, in FIG. 7, logical addresses that are not sequential may be assigned to a same meta data group.

When creating such a meta data group, an over provision ratio may be high and performance of random write is improved.

A data processing device such as a solid state disk (SSD) may include flash memories storing meta data, for example, like FIG. 3. The memory controller 510 may be configured to communicate with the outside (e.g., to a host) through one of various interface protocols such as μSB, MMC, PCI-E, SATA, PATA, SCSI, ESDI and IDE.

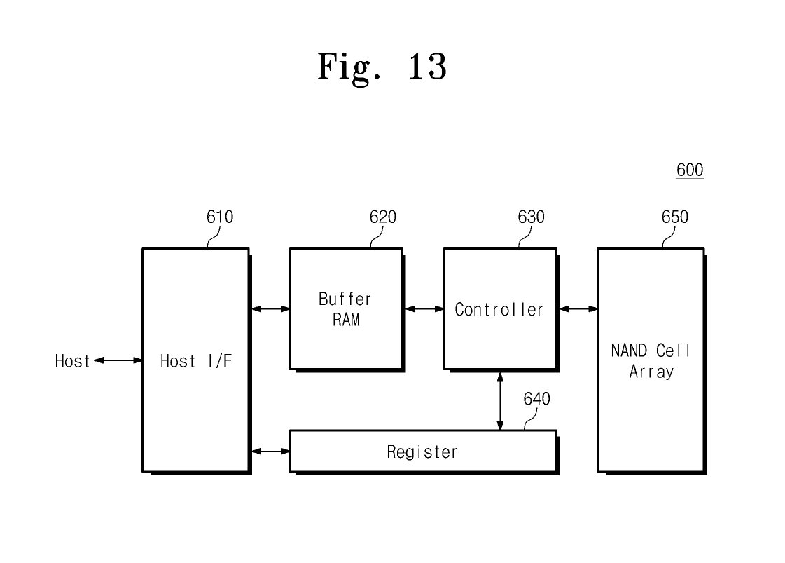

FIG. 13 is a block diagram of another application example as applied to a fusion memory system. In a fusion memory system, a oneNAND flash memory device 600 may be used.

The oneNAND flash memory device 600 may include a host interface for exchanging all sorts of information with a device using a different protocol, a buffer RAM 620 including a code for driving a memory device or temporarily storing data, a controller 630 controlling states (e.g. read, program and so on) in response to a control signal and a command provided from the outside, a register 640 storing a command, an address, and configuration data describing a memory device internal system operation environment, and a NAND flash cell array 650 including a nonvolatile memory cell and a page buffer.

The oneNAND flash memory device 600 may create one or more meta data groups in response to a request from a host.

In an embodiment in which the NAND flash cell array 650 is embodied by a plurality of memory chips, the controller 630 assigns logical addresses to each chip by a fixed size. When creating meta data groups, as described above, for example, in FIG. 7, logical addresses that are not sequential may be assigned to a same meta data group.

Similarly, when creating such a meta data group, an over provision ratio may be high and random write performance of the oneNAND flash memory device 600 is improved.

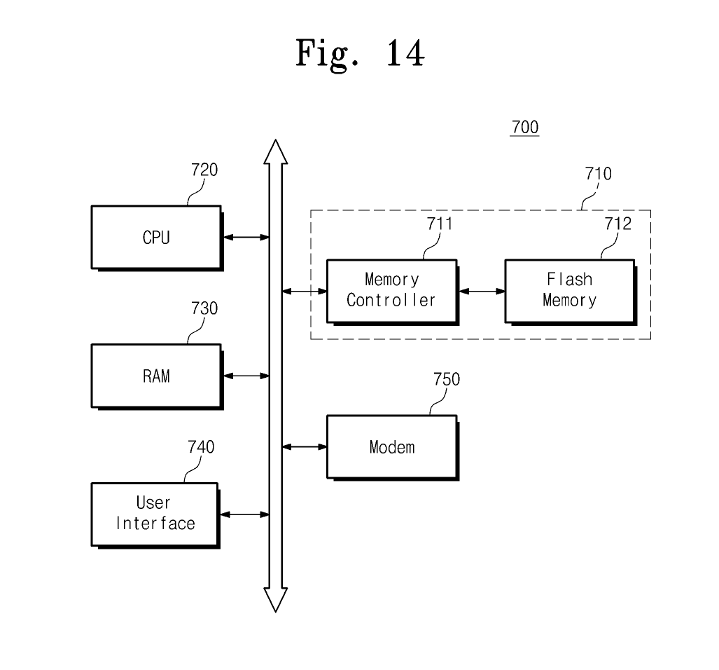

FIG. 14 is a block diagram of another application example as applied to a computing system.

Referring to FIG. 14, the computing system 700 may include a CPU 720, a RAM 730, a user interface 740, a MODEM such as baseband chipset and a memory system 710 including a memory controller 711 and a flash memory 712 that are electrically connected to a system bus 760.

In the embodiments in which the computing system 700 is a mobile device, a battery (not shown) for autonomously supplying an operation voltage of the computing system 700 may be further provided.

In these embodiments in which the computing system 700 is a mobile device, the CPU 720 may be mounted in a dual processor type for dual processing operation. In this case, the RAM 730 may not be set to each processor. The RAM 730 may internally have a dual port and a common memory area so that it may be shared by processors. Minimizing the size of a device and of a terminal is a factor greatly affecting the competitive edge of the product.

In the case that the flash memory 712 is embodied by a plurality of memory chips, the memory controller 711 assigns logical addresses to each chip by a fixed size. When creating meta data groups, as described above, for example, in FIG. 7, logical addresses that are not sequential may be assigned to a same meta data group.

In these embodiments, an over provision ratio may be high and performance of random write of the computing system is improved.

Although not illustrated in the drawing, the computing system 700 may further include, for example, an application chipset, a camera image processor (CIS) and a mobile DRAM. The memory system 710 may be embodied by a solid state disk (SSD) using a nonvolatile memory to store data. In other embodiments, the memory system 710 may be embodied by a fusion flash memory (e.g., oneNAND flash memory).

The flash memory and/or the memory controller may be mounted using various types of packages. For example, the flash memory and/or the memory controller may be mounted using various types of packages such as PoP (package on package), ball grid array (BGA), chip scale package (CSP), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline (SOIC), shrink small outline package (SSOP), thin small outline (TSOP), thin quad flatpack (TQFP), system in package (SIP), multi chip package (MCP), wafer-level fabricated package (WFP) and wafer-level processed stack package (WSP).

According to some embodiments, an over provision ratio of physical space may be high and the random write performance is improved when creating meta data groups with non-sequential logical addresses.

The above-disclosed subject matter is to be considered illustrative and not restrictive, and the appended claims are intended to cover all such modifications, enhancements, and other embodiments, which fall within the true spirit and scope of the disclosed embodiments. Thus, the invention is to be determined by the broadest permissible interpretation of the following claims and their equivalents, and shall not be restricted or limited by the foregoing detailed description.

What is claimed is:

1. A method of creating a plurality of meta data groups for a storage including a plurality of memory devices, the method comprising:
associating a logical address space including a plurality of contiguous sequential logical addresses with the storage;
assigning a first logical address of the logical address space to a logical space of a first meta data group; and
assigning a second logical address immediately sequential to the first logical address to a logical space of a second meta data group, where the second meta data group is different than the first meta data group.

2. The method of claim 1, wherein the first and second logical addresses are associated with a same memory device of the plurality of memory devices.

3. The method of claim 1, wherein each meta data group is configured to store management information to manage the storage, including at least one of the following: name of file data, directory name, access authority to file data, state information about a block area, and state information about a page area.

4. The method of claim 3, wherein a number of logical addresses assigned to a first meta data group is less than a number of physical addresses of the first meta data group.

5. The method of claim 4, wherein an overprovision ratio for the first meta data group is at least 400%.

6. The method of claim 1, further comprising:
assigning logical addresses of the logical address space to one of the plurality of meta data groups based on a modulo function corresponding to a total number of meta data groups.

7. The method of claim 1, further comprising:
assigning logical addresses of the logical address space to one of the plurality of meta data groups based on a function of the bit operation value of the logical address.

8. The method of claim 1, further comprising:
assigning logical addresses of the logical address space to one of the plurality of meta data groups based on a host access pattern in an initialization mode.

9. The method of claim 1, further comprising:
assigning logical addresses of the logical address space to one of the plurality of meta data groups based on a host access pattern on a real time basis.

10. A method of associating adjacent sequential logical addresses of a logical address space of a semiconductor storage device to a plurality of meta data groups for that device, the method comprising:
associating a plurality of sets of logical addresses of the logical address space to a respective plurality of meta data groups, each set of logical addresses comprising an equal amount of logical addresses,
wherein none of the logical addresses in a set of logical addresses are immediately sequential to each other in the logical address space.

11. The method of claim 10, further comprising:
associating a first logical address of a first set of logical addresses to a logical space of a first meta data group; and
associating a second logical address of the first set of logical addresses, the second logical address being contiguous to the first logical address, to a logical space of a second meta data group, where the second meta data group is different than the first meta data group.

12. The method of claim 10, wherein a number of logical addresses associated to a first meta data group is less than the number of physical addresses of the first meta data group.

13. The method of claim 12, wherein an overprovision ratio for the first meta data group is at least 400%.

14. The method of claim 10, further comprising:
associating logical addresses of the logical address space to at least one of the plurality of meta data groups based on a host access pattern of the semiconductor storage device.

15. A semiconductor storage device comprising:
a plurality of semiconductor memory chips, each chip associated with a respective logical address space comprising contiguous logical addresses; and
a controller configured to allocate a plurality of meta data groups for each chip, each meta data group being assigned a set of logical addresses of the logical address space,
wherein the controller is configured to assign a first logical address of a first logical address space to a first meta data group and a second logical address of the first logical address space, contiguous to the first logical address, to a second meta data group, where the second meta data group is different than the first meta data group.

16. The semiconductor storage device of claim 15, wherein the chips are nonvolatile memories.

17. The semiconductor storage device of claim 15, wherein the set of logical addresses allocated to each meta data group are associated with a same chip.

18. The semiconductor storage device of claim 15, wherein a number of logical addresses assigned to the first meta data group is smaller than a number of physical addresses associated with the first meta data group.

19. The semiconductor storage device of claim 18, wherein an overprovision ratio of the first meta data group is at least 400%.

20. The semiconductor storage device of claim 15, wherein the controller is configured to assign logical addresses to each meta data group based on a host access pattern of the chip.
